(19) United States
(12) Patent Application Publication
(10) Pub. No.: US 2017/0021497 A1
(43) Pub. Date: Jan. 26, 2017

(54) COLLABORATIVE HUMAN-ROBOT SWARM

(71) Applicants: Brandon Tseng, San Diego, CA (US); Ryan Tseng, San Diego, CA (US); Andrew Reiter, San Diego, CA (US)

(72) Inventors: Brandon Tseng, San Diego, CA (US); Ryan Tseng, San Diego, CA (US); Andrew Reiter, San Diego, CA (US)

(21) Appl. No.: 15/212,363

(22) Filed: Jul. 18, 2016

Related U.S. Application Data
(60) Provisional application No. 62/196,792, filed on Jul. 24, 2015.

(51) Int. Cl. B25J 9/16; G05D 1/02; G05D 1/00

(52) U.S. Cl. CPC B25J 9/161; G05D 1/0044; G05D 1/0212; B25J 9/1664; G05D 2201/0207; G05D 2201/0209; G05B 2219/40298

(57) ABSTRACT

One or more robots that make exploration and path planning decisions in a previously unknown or unmapped environment based on a map and localization data at least partially generated by human transported perception unit(s). One or more robots that make exploration and path planning decisions in a previously unknown or unmapped environment based on current and past position and velocity information of at least one human. Exploration and navigation recommendations presented to a human based on map and localization information at least partially generated by other humans or robots. A system of humans and robots that generates a map of an environment based data provided from at least one human transported sensor, and at least one robot transported sensor. One or more robots that make navigation, exploration and/or path planning decisions responsive to voice commands that are interpreted taking into consideration map and localization data at least partially generated by human transported perception unit A helmet (vest or other) mounted sensor used to generate map and localization data that is used by robots to make exploration and path planning decisions. A helmet (vest or other) mounted sensor used to generate map and localization data that is used by robots to map and localize themselves within the map.

### CROSS REFERENCE TO RELATED APPLICATIONS

This application claims the benefit of priority under 35 U.S.C. §119(e) to U.S. Provisional Patent Application Ser. No. 62/196,792, titled: “COLLABORATIVE HUMAN-ROBOT SWARM,” filed on Jul. 24, 2015, the entire disclosure of which is hereby incorporated by reference in its entirety for all purposes.

### FIELD OF THE INVENTION

The field of the invention relates to a collaborative human-robot swarm (HRS) and more particularly, to systems, methods and apparatuses for creating or updating a combined map using a collaborative HRS.

### BACKGROUND OF THE INVENTION

Swarms of autonomous robots have been proposed and built to conduct coordinated mapping and exploration using various robots and algorithms. In a typical instantiation, human operators are in a first area and the robots of the swarm are located in a different area. The human operators send instructions, which can be low level inputs or relatively abstract, and then wait for the robots to complete the designated task.

Such an approach has limitations in combat environments where one or more humans and robots operate in overlapping areas, and one in which human operators will maneuver immediately and quickly in response to enemy actions. In this circumstance, the robots will be unable to make optimum path planning decisions. Sub-optimum path planning may result in dangerous human-robot collisions and in time-wasting redundant exploration by humans and robots.

### SUMMARY OF THE INVENTION

The sub-optimum path planning occurs for two main reasons: first, the past, present, and projected future location of the humans with respect to the environment and robots is unknown, and second, the robots do not have access to the humans' awareness of the environment which has been generated during their maneuvers. It is likely that humans' awareness of the environment includes areas that are unknown to the robots.

The issues could be resolved if human operators could share their past, present, and projected future location, along with their awareness of the environment. In a battlefield environment, where human operators are distracted and thus available cognitive capability is limited, communicating such information from humans to robots would be extremely difficult,

Aspects of the current subject can relate to:

One or more robots that make exploration and path planning decisions in a previously unknown or unmapped environment based on a map and localization data at least partially generated by human transported perception unit.

One or more robots that make exploration and path planning decisions in a previously unknown or unmapped environment based on current and past position and velocity information of at least one human.

Exploration and navigation recommendations presented to a human based on map and localization information at least partially generated by other humans or robots.

A system of humans and robots that generates a map of an environment based data provided from at least one human transported sensor, and at least one robot transported sensor.

One or more robots that make navigation, exploration and/or path planning decisions responsive to voice commands that are interpreted taking into consideration map and localization data at least partially generated by human transported perception unit.

A helmet (vest or other) mounted sensor used to generate map and localization data that is used by robots to make exploration and path planning decisions.

A helmet (vest or other) mounted sensor used to generate map and localization data that is used by robots to map and localize themselves within the map.

One aspect of the current subject matter describes a collaborative HRS for mapping and exploration.

A collaborative HRS for mapping is difficult for many reasons, several of which are described in this paragraph. The sensor payload transported by humans will shift and jostle during operation. Data generated by a human sensor payload must be corrected to account for this instability. Maps generated by individual members of the HRS may not overlap for long periods of time, this means that combining the maps can be data or computationally intensive. This is because individual members must retain knowledge of key environmental features, and compare those features against other features detected by other members of the swarm. Human behavior is difficult to anticipate, robots will have to make predictions based on current and past position and velocity information.

The HRS is comprised at least one human and at least one robot. A minimum configuration includes one human and one robot. Another configuration includes one human and more than one robot. Another configuration includes more than one human and one robot. Another configuration includes more than one human and more than one robot. The population of the HRS can change as humans and robots join or leave.

Humans of the HRS are equipped with a Sensor Payload, Computer, and/or Data Link. In some applications the sensor payload, computer and/or data link can be collectively referred to as a Human Perception Unit. Robots of the HRS are equipped with a Sensor Payload, Computer, and Data Link. In some applications the sensor payload, computer, and/or data link can be collectively referred to as a Robot Perception Unit, Members of the HRS are able to communicate with each other directly or indirectly via the Data Links. The Data Links can be connected in a star, mesh, or peer-to-peer network topology. The members of the HRS may communicate with a server, or the cloud, which can act as an intermediary between members. The server and/or cloud may run algorithms, store data, and manage member additions and subtractions among other things. The server, or the cloud, can provide additional functionality to the HRS.

In some variations one or more members of the HRS can be designated as master members. The master member(s) can control communications between the members of the HRS. Data signals can be transferred between the master member(s) and the other members of the HRS. The master member(s) can be configured to coordinate the other members of the HRS. The master member(s) can be in electronic communication with one or more servers. The server(s) can be configured to provide additional functionality to the HRS through the master member(s).

In some variations, as human and robot members of the HRS move through an environment, the Human Perception Unit(s) and Robot Perception Unit(s) can be configured to create, process, and exchange data to create and update a Combined Map that is shared amongst members the HRS. Current and historical Localization Data describing position, orientation, velocity, and acceleration can be generated and shared amongst members of the HRS. The current and historical localization data can be maintained by each of the members, a master member(s), and/or on a server(s). Processing of the current and historical localization data can be shared among the members of the HRS.

In some variations, the Combined Map can include the location of notable objects or people, such as friendly forces and enemy combatants. The notable objects or people can be added to the Combined as they are recognized and localized. The notable objects can be tracked as they move. The notable objects and people can be recognized by one or more members of the HRS in many ways, a few of which include visual recognition, signal recognition, wearable beacons, or tagged via a user interface. When a notable object or person is recognized, a notification can be sent to all members of the HRS. Robots may make path planning decisions based on the location of the notable objects and people. Humans may be provided with path recommendations based on the location of notable objects or people. Humans in the HRS may be provided with information concerning the direction to, and distance from notable objects and people.

The path planning decisions by the robots can be performed by processor(s) on one or more of the robots, processor(s) on servers in communication with the robot(s), processor(s) on mobile devices in communication with the robot(s) and/or other devices with processing capabilities.

In some variations, the Human Perception Unit(s) can be configured to provide the majority of the processing capabilities of the members of the HRS.

The Combined Map and Localization Data are used by members of the Swarm to inform and coordinate exploration and path planning.

A Human Perception Unit can be the same or identical to a Robot Perception Unit Robots and humans differ in many regards including payload capacity, means of locomotion, and size. Thus in some configurations, a Human Perception Unit and a Robot Perception Unit are different. As an example, a Human Perception Unit can be integrated into a helmet, backpack, or vest for easy transport.

Thus, in one embodiment the disclosure provides a computer-implemented method for creating or updating a combined map using a collaborative HRS, which includes: receiving at least one data input by a server or by at least one member of the collaborative HRS, from at least one human of the collaborative HRS moving through a first environment, the at least one human equipped with at least one human perception unit including a sensor payload, a computer/processor, and a data link; receiving at least one data input at the server or at the at least one member of the collaborative HRS, from at least one robot of the collaborative HRS moving through a second environment, the at least one robot equipped with at least one robot perception unit including a sensor payload, a computer/processor, and a data link; and processing the received data inputs from the at least one human and the at least one robot at the server or at the at least one member of the collaborative HRS, to create or update the combined map of the first and second environments.

In one aspect, the disclosure provides a computer-implemented method for creating or updating a combined map using a collaborative HRS, which further includes: transmitting the created or updated combined map to the at least one human, the at least one robot, or to at least one other member of the collaborative HRS.

In another aspect, the disclosure provides a computer-implemented method for creating or updating a combined map using a collaborative HRS, which further includes; integrating at least one of the human or robot perception units into an unmanned aerial vehicle (UAV), a helmet, a backpack, or a vest.

In another aspect, the disclosure provides a computer-implemented method for creating or updating a combined map using a collaborative HRS, which further includes: at least one of the sensor payloads of the human or robot perception units including a scanning Light Detection And Ranging (LIDAR), Sound Navigation And Ranging (SONAR), inertial measurement unit (IMU)|, Electro-Optical (EO) camera, Thermal camera, Depth camera, Near Infrared (NIR) camera, Compass, WiFi (wireless local area network (WLAN)), Global System for Mobile Communications (GSM), Long-Term Evolution (LTE), Code Division Multiple Access (CDMA), Near Field Communication (NFC), Global Positioning System (GPS), RF transmitter, RF receiver technology, or a combination thereof.

In another aspect, the disclosure provides a computer-implemented method for creating or updating a combined map using a collaborative HRS, which further includes: processing the data inputs from the at least one human perception unit and/or the at least one robot perception unit using Simultaneous Location And Mapping (SLAM) techniques.

In another aspect, the disclosure provides a computer-implemented method for creating or updating a combined map using a collaborative HRS, which further includes: configuring the computer/processor of at least one human or robot perception unit to run individual mapping software for generating a map of the first or second environment, respectively.

In another aspect, the disclosure provides a computer-implemented method for creating or updating a combined map using a collaborative HRS, which further includes: processing the data inputs from the at least one human perception unit and the at least one robot perception unit by generating and fusing maps together from the sensor payloads of the at least one human and the at least one robot perception units, respectively.

In another aspect, the disclosure provides a computer-implemented method for creating or updating a combined map using a collaborative HRS, which further includes: communicating between the at least one human and the at least one robot of the collaborative HRS directly or indirectly through the data links.

In another aspect, the disclosure provides a computer-implemented method for creating or updating a combined map using a collaborative HRS, which further includes: designating one or more members of the collaborative HRS as master members, wherein the master members control communications between the members of the collaborative HRS.

In another embodiment, the disclosure provides an apparatus, which includes: at least one processor; and at least one memory including computer program code for one or more programs, the at least one memory and the computer program code configured to, with the at least one processor, cause the apparatus to perform at least the following: receive at least one data input by a server or by at least one member of a collaborative HRS, from at least one human of the collaborative HRS moving through a first environment, the at least one human equipped with at least one human perception unit including a sensor payload, a computer/processor, and a data link; receive at least one data input at the server or at the at least one member of the collaborative HRS from at least one robot of the collaborative HRS moving through a second environment, the at least one robot equipped with at least one robot perception unit including a sensor payload, a computer/processor, and a data link; and process the received data inputs from the at least one human and the at least one robot at the server or at the at least one member of the collaborative HRS, to create or update the combined map of the first and second environments.

In one aspect, the disclosure provides an apparatus, which includes: at least one processor; and at least one memory including computer program code for one or more programs, the at least one memory and the computer program code configured to, with the at least one processor, further cause the apparatus to: transmit the updated or combined map to the at least one human, the at least one robot, or to at least one other member of the collaborative HRS.

In another aspect, the disclosure provides an apparatus, which includes: at least one processor; and at least one memory including computer program code for one or more programs, the at least one memory and the computer program code configured to, with the at least one processor, further cause the apparatus to: integrate at least one of the human or robot perception units into an unmanned aerial vehicle (UAV), a helmet, a backpack, or a vest.

In another aspect, the disclosure provides an apparatus, which includes: at least one processor; and at least one memory including computer program code for one or more programs, the at least one memory and the computer program code configured to, with the at least one processor, further cause the apparatus to: include at least one of the sensor payloads of the human or robot perception units to include a scanning Light Detection And Ranging (LIDAR), Sound Navigation And Ranging (SONAR), inertial measurement unit (IMU)|, Electro-Optical (EO) camera, Thermal camera, Depth camera, Near Infrared (NIR) camera, Compass, WiFi (wireless local area network (WLAN)), Global System for Mobile Communications (GSM), Long-Term Evolution (LTE), Code Division Multiple Access (CDMA), Near Field Communication (NFC), Global Positioning System (GPS), RF transmitter, RF receiver technology, or a combination thereof.

In another aspect, the disclosure provides an apparatus, which includes: at least one processor; and at least one memory including computer program code for one or more programs, the at least one memory and the computer program code configured to, with the at least one processor, further cause the apparatus to: process the data inputs from the at least one human perception unit and the at least one robot perception unit using Simultaneous Location And Mapping (SLAM) techniques.

In another aspect, the disclosure provides an apparatus, which includes: at least one processor; and at least one memory including computer program code for one or more programs, the at least one memory and the computer program code configured to, with the at least one processor, further cause the apparatus to: configure the computer/processor of at least one human or robot perception unit to run individual mapping software for generating a map of the first or second environment, respectively.

In another aspect, the disclosure provides an apparatus, which includes: at least one processor; and at least one memory including computer program code for one or more programs, the at least one memory and the computer program code configured to, with the at least one processor, further cause the apparatus to: process the data inputs from the at least one human perception unit and the at least one robot perception unit by generating and fusing maps together from the sensor payloads of the at least one human and the at least one robot perception units, respectively.

In another aspect, the disclosure provides an apparatus, which includes: at least one processor; and at least one memory including computer program code for one or more programs, the at least one memory and the computer program code configured to, with the at least one processor, further cause the apparatus to; communicate between the at least one human and the at least one robot of the collaborative HRS directly or indirectly through the data links.

In another aspect, the disclosure provides an apparatus, which includes: at least one processor; and at least one memory including computer program code for one or more programs, the at least one memory and the computer program code configured to, with the at least one processor, further cause the apparatus to: designate one or more members of the collaborative HRS as master members. wherein the master members control communications between the members of the collaborative HRS.

In another embodiment, the disclosure provides collaborative HRS for creating or updating a combined map, which includes: at least one human of the collaborative HRS moving through a first environment, the at least one human equipped with at least one human perception unit including a sensor payload, a computer/processor, and a data link for receiving and/or transmitting data to a server or to at least one member of the collaborative HRS; and at least one robot of the collaborative HRS moving through a second environment, the at least one robot equipped with at least one robot perception unit including a sensor payload, a computer/processor, and a data link for receiving and/or transmitting data to the server or to the at least one member of the collaborative HRS, wherein the server or the at least one other member of the collaborative HRS processes the received data inputs from the at least one human and the at least one robot to create or update the combined map of the first and second environments.

In one aspect, the disclosure provides collaborative HRS for creating or updating a combined map, wherein the created or updated combined map is transmitted to the at least one human, the at least one robot, or to at least one other member of the collaborative HRS.

### BRIEF DESCRIPTION OF THE DRAWINGS

The following figures are illustrative of one or more elements of the current subject matter and are not intended to be limiting.

FIG. 1 is an illustration of a helmet with an integrate sensor payload, having one or more elements consistent with the currently described subject matter;

FIG. 2 shows the fusion of maps and localization data from members of a HRS to create Master Map and Master Localization Data, the members of the HRS having one or more elements consistent with the current subject matter.

FIG. 3 shows a composition of a Human Perception Unit, having one or more elements consistent with the currently described subject matter;

FIG. 4 shows the composition of the Robot Perception Unit, having one or more elements consistent with the currently described subject matter.

FIG. 5 shows a process of a member joining an HRS, having one or more elements consistent with the currently described subject matter;

FIG. 6 illustrates exploration of an HRS in which the robot has awareness of the exploration completed by the human, and of the past and current position of the human, having one or more elements consistent with the currently described subject matter;

FIG. 7 illustrates human robot exploration, having one or more elements consistent with the currently described subject matter;

FIG. 8 illustrates the navigation of a robot to the location of a human, in which the robot has awareness of the exploration completed by the human, and of the past and current position of the human, having one or more elements consistent with the current subject matter; and

FIG. 9 illustrates the navigation of a robot to the location of a human, having one or more elements consistent with the current subject matter.

### DETAILED DESCRIPTION OF THE INVENTION

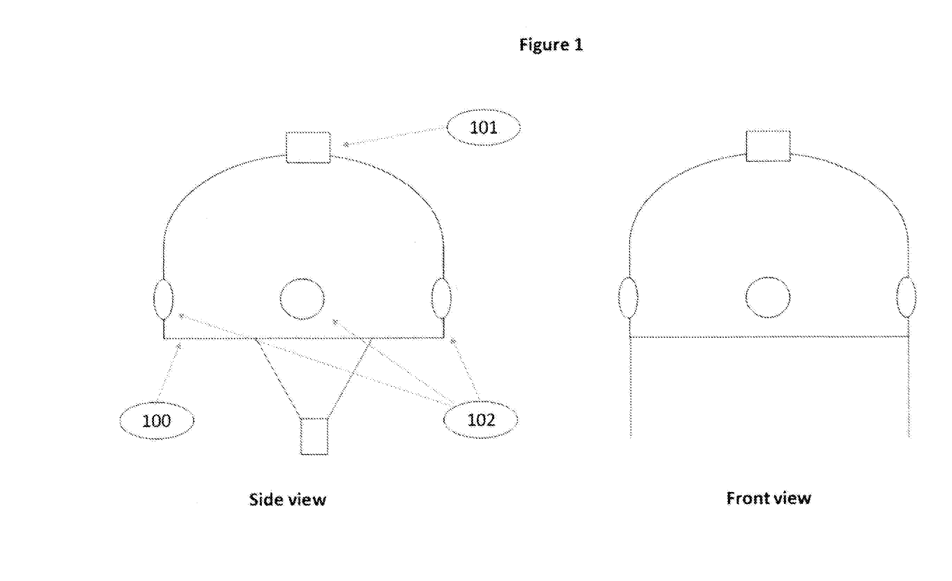

FIG. 1 is an illustration of an example of a helmet with an integrate sensor payload. The helmet 100 can be configured to support a computer and LIDAR. In some variations, the helmet 100 can be configured to support a computer and LIDAR in a single enclosure 101 atop the helmet. The sensor payload can be configured to include one or more cameras 102. The one or more cameras 102 can be disposed around the perimeter of the helmet 100.

The payload sensors supported by humans and robots can be configured to generate maps and localization data from sensor data generated by the payload sensors using a variety of techniques. One such technique include SLAM (Simultaneous Location And Mapping) techniques. Statistical techniques include Kalman filters, particle filters (aka. Monte Carlo methods) and scan matching of range data. They can be configured to provide an estimation of the posterior probability function for the pose of the robot and for the parameters of the map.

Bundle adjustment is another technique for SLAM using image data. Bundle adjustment jointly estimates poses and landmark positions. Bundle adjustment can increase map fidelity. Examples of bundle adjustment are used in many recently commercialized SLAM systems such as Google's Project Tango.

New SLAM algorithms remain an active research area, and are often driven by differing requirements and assumptions about the types of maps, sensors and/or models as detailed below. SLAM systems can be configured to account for combinations of choices from one or more of these aspects, as well as other aspects.

Maps generated from the payload sensors of different EMS members can be fused together. The fusion of the maps may be accomplished by using loop closure techniques. The loop closure techniques can be completed by individual robots. Loop closure recognizes previously-visited locations and updates the beliefs accordingly. Use of loop closure enables bounded error performance. A loop closure method can be configured to apply an algorithm to measure sensor similarity between sensors.

The sensors could be the same could be the same or they could be different. Sensor data from any combination of robots and humans can be used. A single sensor can be used, such as a single camera traveling along a closed path. Multiple sensors can be used, such as two cameras traveling along a common or closed path, or if the cameras are transported separately, along an intersecting path. Loop closure could be completed by using data different from types of sensors, such as an EO and Thermal camera. A LIDAR could be used in combination with another LIDAR. A LIDAR could be used in combination with a camera.

The loop closure method can be configured to re-set or adjust the location priors when a match is detected between the measurements made by a first sensor and the measurements made by a second sensor. Location priors are the areas where that have been previously mapped, and/or where the human or robot has localized itself in the environment.

A match between two sets of measurements from two sensors can be where the sensor measurements are within a predetermined threshold of one another. For example this can be done by storing and comparing bag of words vectors of scale-invariant feature transform features from each previously visited location. The computation to find a match can be completed by a single member or distributed amongst multiple members of the HRS. The computation could be completed by a master member or a server, and the results could be shared with members of the HRS. In one example, a first level of computation is completed by a single member of the HRS to determine if the probability of a loop closure exceeds a target threshold. If the probability of the loop closure is above the threshold, the remainder of the computation is distributed to other members of the HRS, or to a master member for a second level of computation that determines with greater accuracy, whether a loop closure has actually occurred.

Algorithms may be used to reduce the amount of data and computation required for map fusion. Location utility-based map reduction is one such approach.

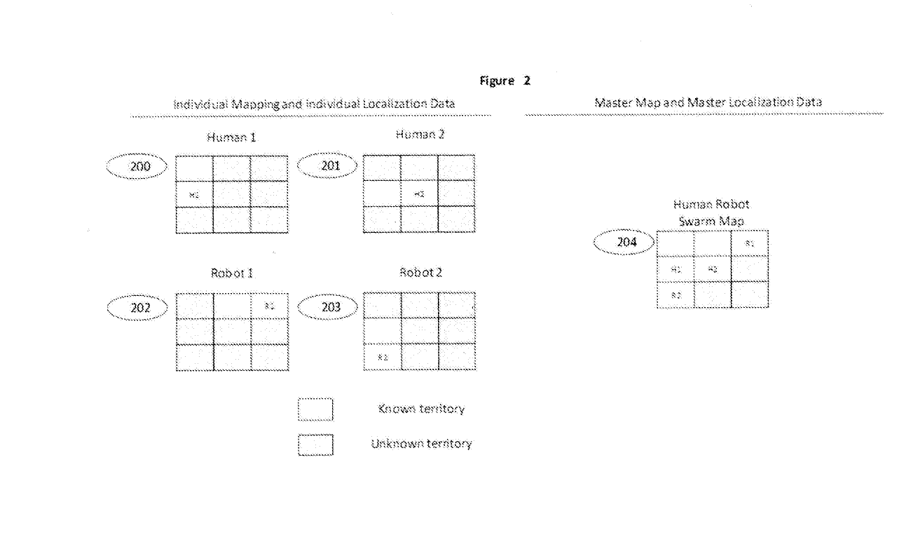

FIG. 2 shows the fusion of maps and localization data from members of a HRS to create Master Map and Master Localization Data. The 9-rectangular grids represent an area to be explored. The area can be explored by a human(s) and a robot(s). Grid maps 200, 201, 202 and 203 represent the individual map and localization data generated by four members of a HRS; Human 1, Human 2, Robot 1 and Robot 2, respectively. Grid map 204 represents the Master Map and Master Localization Data created by the fusion of grid maps 200, 201, 202, and 203.

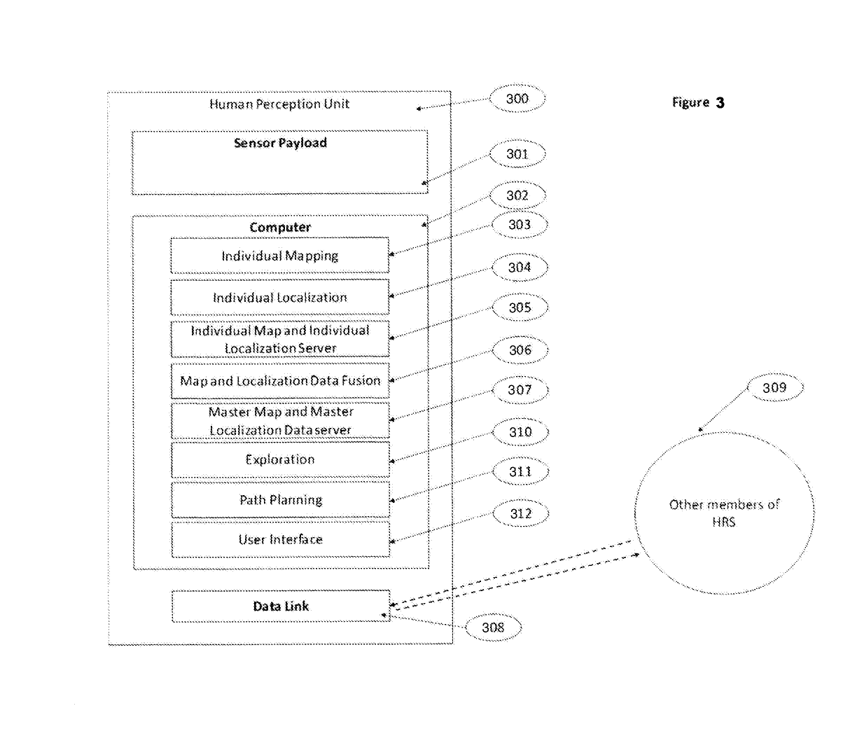

FIG. 3 shows the composition of a Human Perception Unit. The Human Perception Unit 300 can comprise a Sensor Payload 301, Computer/processor(s) 302, Data Link 308 and/or other elements. The computer can be configured to run Individual Mapping software 303. The individual mapping software 303 can be configured to cause the generation of a map, The map can be based on data generated by measurements from Sensor Payload 301. The processor(s) can be configured to run Individual Localization software 304. The individual localization software can be configured to generate Localization Data based on data generated from measurements by Sensor Payload 301. The map and Localization Data can be made available to Other Members of the HRS 309. This information can be shared between other members of the HRS 309 through the Individual Map and Individual Localization Server 305 via Data Link 308. Individual Maps and Individual Localization Data from Other Members of the HRS 309 can be accessed via Data Link 308. Map and Localization Fusion software 306 can be configured to cause the creation of Master Map and Master Localization Data. Master map and master localization data can be created by combining the map and localization information created by individual mapping software 303 and individual localization software 304 with Map and Localization information from 309. The Master Map and Master Localization Data can be made available to Other Members of the HRS on the Master Map and Master Localization Data Server 307 via Data Link 308. Exploration software 310 can be configured to cause selection of areas that are unexplored and/or areas that are ancient to explore based on the Master Map and Master Localization Data. Path Planning software 311 can be configured to determine an optimum route to reach the areas selected by exploration software 310. User Interface 312 can be configured to display relevant information to the Human. Relevant information may include Map and Localization Data generated or stored by 303, 304, 305, 306, 307, or 309. Relevant information may include video streams generated by 309. Relevant information may include exploration and path-planning suggestions generated by 310 or 311. 312 is can be used to facilitate input of commands.

Commands can be shared with 309.

The Human Perception Unit can include other elements to those described herein. The Human Perception Unit can include elements in addition, to or as alternatives of, the elements described herein. One of ordinary skill in the art would appreciate and understand that there are many other possible instantiations of a Human Perception Unit. The processes described herein can be performed by hardware, software, firmware, other elements, and/or a combination thereof. Processes attributed to one element can be performed by other elements and/or alternative elements, and the functionality described herein is not intended to be limiting.

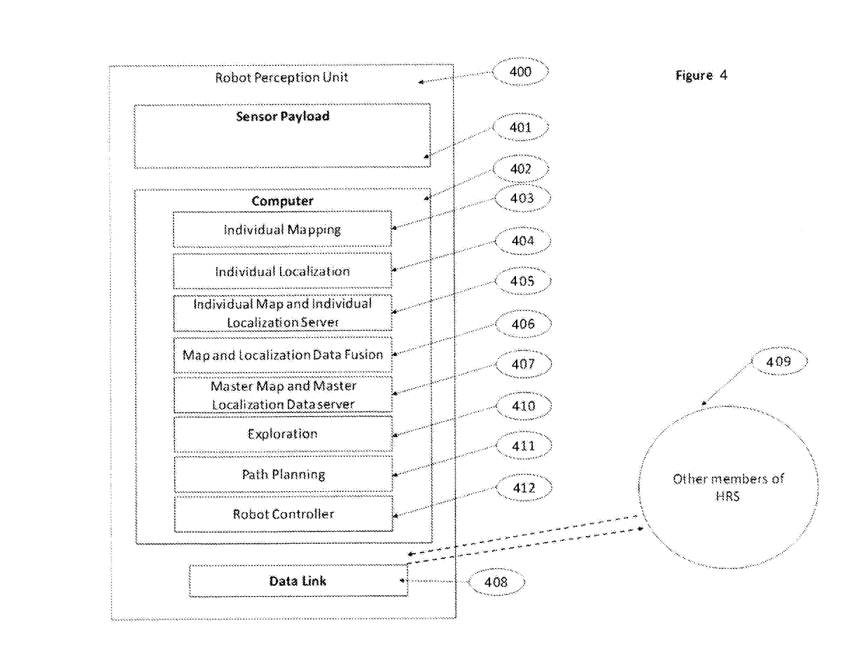

FIG. 4 shows the composition of the Robot Perception Unit. The Robot Perception Unit 400 can be comprised of a Sensor Payload 401, a Computer/processor(s) 402, and/or a Data Link 408. The processor(s) can be configured to run Individual Mapping software 403. Individual mapping software 403 can be configured to cause the generation of a map. The map can be generated based on data generated from measurements by the Sensor Payload 401. The computer/processor(s) can be configured to run Individual Localization software 404.

Individual localization software 404 can be configured to cause the generation of Localization Data based on data generated by Sensor Payload 401. The map and Localization Data can be made available to Other Members of the HRS 409. The map and localization data can be made available on the Individual Map and Individual Localization Server 405 via Data Link 408. Individual Maps and Individual Localization Data from Other Members of the HRS 409 can be accessed via Data Link 408. Map and Localization Fusion software 406 can be configured to create Master Map and Master Localization Data by combining the map and localization information created by 403 and 404 with Map and Localization information from 409. The Master Map and Master Localization Data can be made available to Other Members of the HRS on the Master Map and Master Localization Data Server 407 via Data Link 408. Exploration software 410 can be configured to select areas that are unexplored and/or areas that are efficient to explore based on the Master Map and Master Localization Data. Path Planning software 411 can determine an optimum route to reach the areas selected by 410.

Robot controller 412 can be configured to control one or more motive elements of the robot. The controller 412 can be configured to actuate the robot to follow the defined route. 412 can cause the robot to respond to commands received from 409. 412 can produce commands to influence 409.

The Robot Perception Unit can include other elements to those described herein. The Robot Perception Unit can include elements in addition, to or as alternatives of, the elements described herein. One of ordinary skill in the art would appreciate and understand that there are many other possible instantiations of a Robot Perception Unit. The processes described herein can be performed by hardware, software, firmware, other elements, and/or a combination thereof. Processes attributed to one element can be performed by other elements and/or alternative elements, and the functionality described herein is not intended to be limiting.

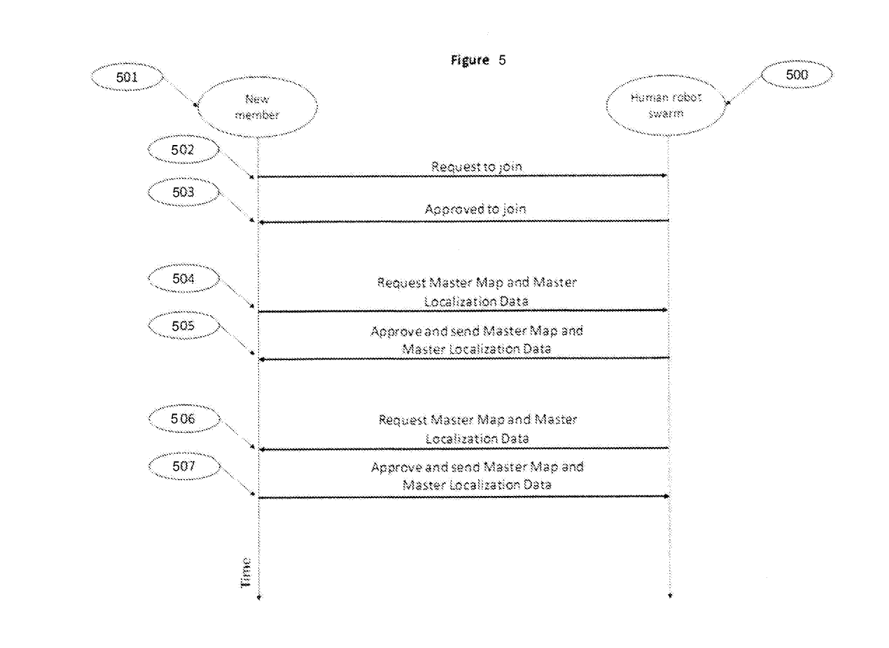

FIG. 5 shows an exemplary process of a new member 501 joining an HRS 500. The process shown in FIG. 4 is illustrative only, One of ordinary skill in the art would appreciate and understand that there are many other possible ways for members to join an HRS and exchange data within the HRS. The new member could be a human or a robot. At time 502, 501 sends a request to join 500. At time 503 at least one member of 500 approves the request from 501. At time 504, 501 requests the Master Map and Master Localization Data from 500. At time 505, at least one member of 500 approves and sends the Master Map and Master Localization data to 501. At time 506, 500 at least one member requests the Master Map and Master Localization Data from 501. At time 507, 501 approves and sends the Master Map and Localization data to 500.

In some variations, only authorized members will be allowed to join the swarm. Whether members are authorized can be determined by exchanging unique data, exchanging patterns of data, communicating according certain timing requirements, performing computations on data, or any of a variety of other known authorization methods. All communication events should be secured. Security can be obtained in many ways including but not limited to encryption, steganography, identity based networking, anonymized networks. Members can be dropped if it is detected that they don't meet the security requirements of the HRS.

One or more aerial, ground, and/or submersible robots may be used. Aerial robots may be fixed wing, single rotor, multi-rotor, and/or other type of aircraft. Ground robots may be treaded, wheeled, and/or legged. HRS may be comprised of many different types of robots having different features and capabilities.

A Sensor Payload for a robot or a human includes one or more of the following sensors: a scanning LIDAR, an EO camera, and/or a depth camera. A Sensor Payload may include an NIR camera, Thermal camera, Sonar, Compass, and/or IMU. A Sensor Payload can be comprised of a single sensor, or combination of sensors. The sensor payload can be configured to produce data, which through computation, can facilitate production of a map of the environment and localize the sensor payload location within the map. The following Sensor Payload configurations are examples of sensor payloads that can be configured to produce the necessary data:

| Sensor | Included sensors |
|---|---|
| 1 | LIDAR |
| 2 | EO Camera |
| 3 | LIDAR, EO Camera, Sonar, IMU, Depth |
| | Camera, NIR Camera, Thermal camera, |
| | Compass, WiFi, GSM, LTE, CDMA, Bluetooth, |
| | GPS, RF transmitter, RF receiver, |
| | RF transceiver |
| 4 | 4 × EO Camera |

The configurations listed in the table are a subset of many possible configurations. To improve mapping and localization it is may be advantageous to incorporate a combination of sensors in the Sensor Payload to provide more data, and more types of data. In some variations, the HSR can comprise multiple humans and/or multiple robots. The sensor payload on any one robot and/or human can be different than the sensor payload on any other one robot and/or human. Providing different payload configurations to different members of an HSR can provide one or more operational benefits. For example: small, lightweight, low performance payloads can be provided to aerial robots with limited payload capacity; medium weight, medium performance payloads can be provided to humans; heavyweight, high performance payloads can be provided to ground robots with high payload capacity.

Sensors may be included to compensate for physical instability of other sensors. For instance, if a camera is mounted on the helmet of a human, it will follow a very unstable trajectory through space due to the human's movement and possibly also uneven terrain. It will shift up, down, forward, backward, and it will roll, pitch, and yaw. This can lead to camera data that is difficult to use for mapping. Sensors like an IMU can be used provide inertial data that can be used to better understand the camera data for mapping and navigation.

A LIDAR (also written Lidar, LiDAR or LADAR) is a remote sensing technology that measures distance by illuminating a target with a laser and analyzing the reflected light. Many scanning LIDARs have the advantage of providing accurate, long range, high speed depth data spanning a large field of view. Such data is especially useful for localization and mapping.

Sonar (originally an acronym for SOund Navigation And Ranging) is a technique that uses sound propagation to detect objects in an environment. Sonar can be used to avoid obstacles or find and localize objects like windows, which might be invisible, or difficult to detect for optical or laser sensors like cameras and MAR.

An inertial measurement unit (IMU) is an electronic device that measures and reports velocity, orientation, and gravitational forces, using a combination of accelerometers and gyroscopes, sometimes also magnetometers. IMUs are typically used to maneuver aircraft, including unmanned aerial vehicles (UAVs), among many others, and spacecraft, including satellites and landers. The IMU can also be used to estimate velocity and distance traveled. It can also be used to stabilize a robot, like a quadrotor aircraft. The IMU can also correct data captured by other sensors. Consider the following example. A 2D scanning LIDAR is placed at the center of a square room with perfectly vertical walls. The LIDAR is oriented so that laser scan is orthogonal to the walls. In this position and orientation, the LIDAR will accurately measure the shortest distance from the LIDAR to each wall. If the LIDAR is tilted, the distance measurements to one or more walls, or sections of walls, will increase, even though the distance between the LIDAR and each wall has not changed. Such a situation could cause a robot to collide with a wall. If an IMU is present, it can detect the tilt and the distance measurements can be corrected to account for the tilt.

A depth camera is a device that measures distances to objects in a scene. A depth camera can be implemented in a number of ways. One approach is the use of a range imaging camera system that resolves distance based on the known speed of light, measuring the round-trip time-of-flight of a light signal emitted from the camera, reflected off the subject, and observed by the sensor for each point in the image. Another involves the use of a camera and structured light projector to triangulate distance at each point. The depth camera can be used to map and localize the robot. The depth camera can be used for obstacle detection and avoidance. The depth camera can be used to detect important features like doorways and stairwells.

WiFi, GSM, LTE, CDMA, Bluetooth, GPS, Near-Field Communication, sub-GHz, and/or any other RF receiver, transmitter, or transceiver can be used for communication. Similar RF technology can be used for localization using one or more locating algorithms, such as trilateration, multilateration, triangulation or other locating algorithms. These technologies can be used to localize robots with respect to each other and the environment.

A Computer may comprise one or more data processors. The one of more processors can be configured to facilitate the operation of one or more operating systems. As referred to herein, a computer or a processor can refer to multiple computers and/or multiple processors. The processors can be logically and/or physically co-located or separate. The Computer may be in the form of a phone, tablet, watch, or embedded in another object. The computer may be comprised of many individual computers acting together. The computer may include a mobile device. The mobile device can include a tablet, smartphone, cellphone, laptop computer, smart watch, smart device, and/or other mobile device.

A benefit provided by one or more elements of the presently described HRS is that it can significantly improve exploration. Other benefits include improving application specific performance relative to humans alone, or robotic swarms alone.

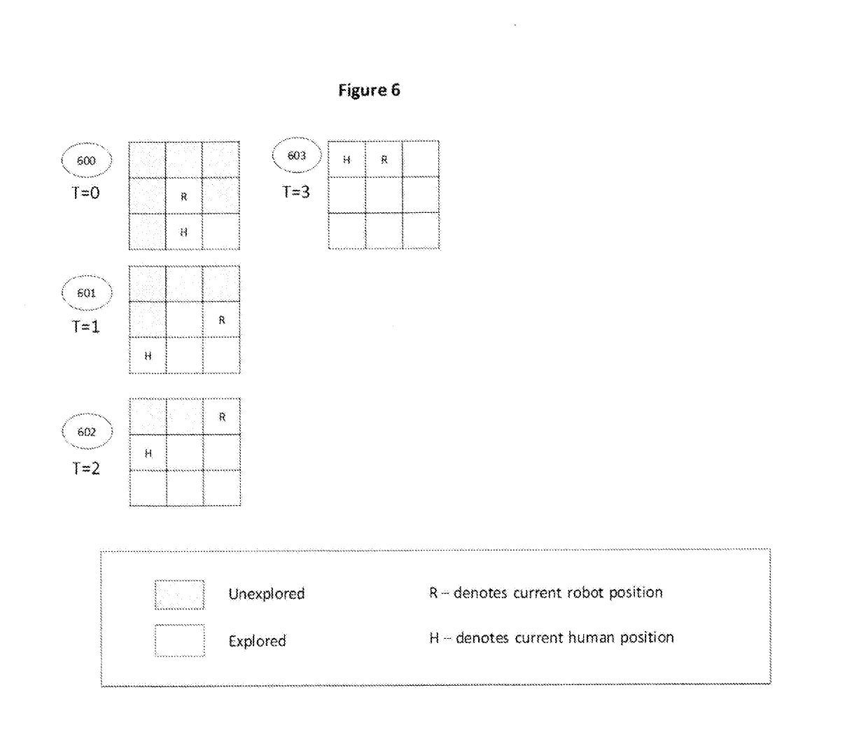

Some advantages of the proposed system are illustrated by at least FIGS. 6, 7, 8, and 9. The 9-rectangular grids of these figures represent an area to be explored or navigated by a human and/or a robot as part of an HRS.

The moment in time represented by each grid is indicated by a value of T. T=0 is the earliest unit of time. Higher values of T correspond to later moments in time.

Within the grid, the Humans and Robots can move up, down, left, or right to an adjacent cell, but no further with each unit of time. Diagonal movement is not allowed. Passing through the outermost wall of the grid is not allowed.

Once a human or robot has entered a territory, it is considered explored.

The robots in the swarm can be configured to automatically coordinate movements and optimize exploration with human counterparts. This facilitates the ability of humans to maneuver swiftly and immediately in response to enemy maneuvers or attacks without being interrupted by a robot.

Robots can be provided information describing exploration completed by humans. Robots can be provided information describing the past and current position of the human(s). As humans maneuver, the map and their position can be updated.

Robots can use this information to avoid obstructing or otherwise encumbering movements of humans.

Further, this approach ensures that areas are explored as quickly and efficiently as possible. By reducing or eliminating redundant exploration by humans and robots, the robots can focus more attention on exploring new territory which is the most dangerous for humans.

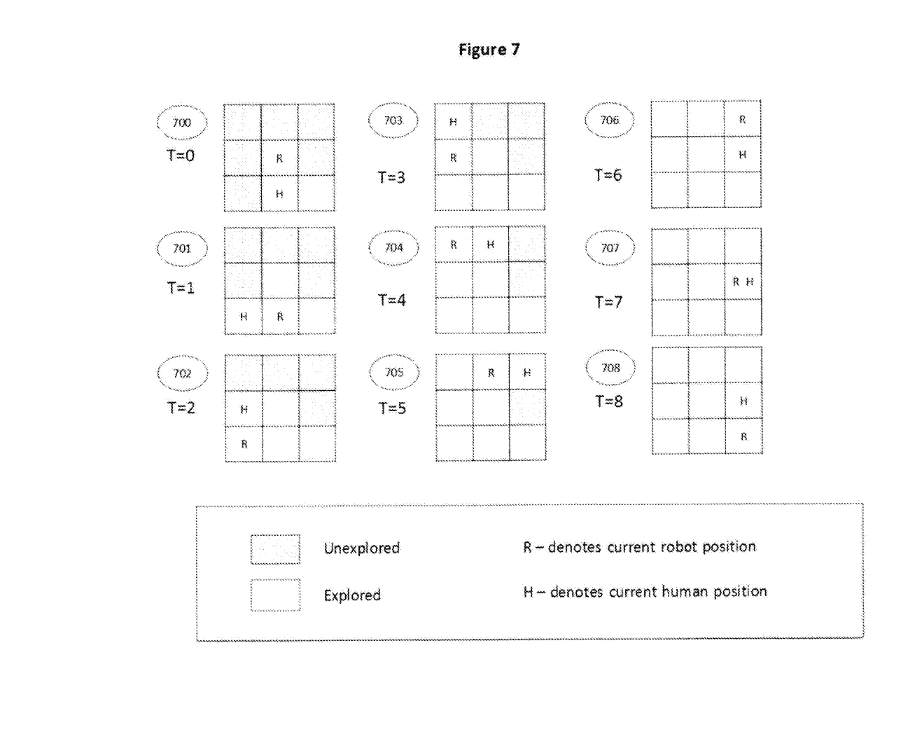

In FIGS. 6 and 7, the objective is for the Robot and Human to explore a territory as quickly as possible and minimize instances of the robot being located in the same territory as a human. The Robot should not enter a territory occupied by a human and exploration should stop after the task has been complete.

FIG. 6 illustrates exploration of an HRS in which the robot has awareness of the exploration completed by the human, and of the past and current position of the human. The robot optimizes path planning with this information.

At grid 600, the robot is at the center position, the human is at the lower-middle position, and the human has already visited the lower-right. At grid 601, the robot has moved right, and the human has moved left. At grid 602, the robot and human have moved up. At grid 603, robot has moved left, and the human has moved up in the final unexplored territory.

By T=3, all territory has been explored by either a robot or human and the task is completed. At the time of completion, the robot and human have not explored any of the same territory. The robot knows the task is complete and stops further exploration.

FIG. 7 illustrates human robot exploration. In this example, the robot has no awareness of the exploration completed by the human or the past or current position of the human.

At grid 600, the robot is at the center position, the human is at the lower-middle position, and the human has already visited the lower-right. At grid 701, the robot has moved down, the human has moved left. The human travels clockwise, and the robot follows in grid 702, 703, 704, 705, and 706. At grid 706, the task is complete, but the robot does not know. At grid 707, the robot has moved down. At grid 708, the robot has moved down.

By T=6 the objective is complete. The time required for completion is longer when compared to the example illustrated in FIG. 6. The robot continues exploring even after the task is complete.

A HRS can generate a large map that enables robots to navigate more easily. This can enable humans to interact with robots at a higher level of abstraction. Cumbersome controls cause inefficient use of robots in the field. Providing a control system that facilitates interaction with robots at a higher level of abstraction can reduce or eliminated cumbersome controls. Such cumbersome control systems that could be reduced or eliminated include, but are not limited to:
1) Assisting UAVs with pathfinding by using basic joystick controls; and
2) Selection of the optimal UAV to execute human specified exploration tasks.

When interaction at high levels of abstraction becomes possible, natural language interface to the robots is feasible. The robots can be configured to receive command phrases. The robots can be configured to respond to those command phrases. Such command phrases can include, for example only, “Go to the northwest corner of this house”, “Come here”, and “Meet me by the south exit.”

A simplified interface is critical to facilitate human-robot interaction where humans are operating in very dangerous and dynamic environments. A human engrossed in commanding robots will be less aware of the immediate surroundings and less capable of coordinating operations with his human counterparts.

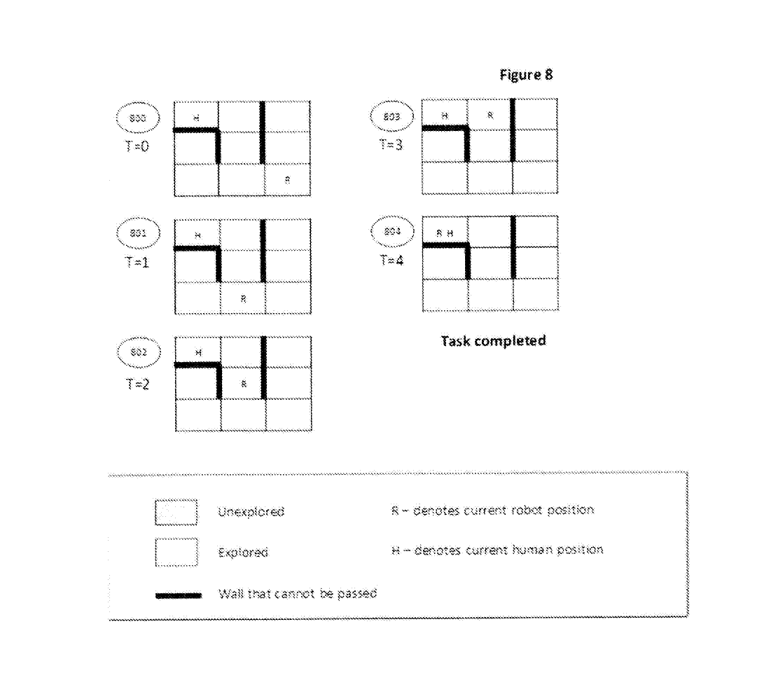

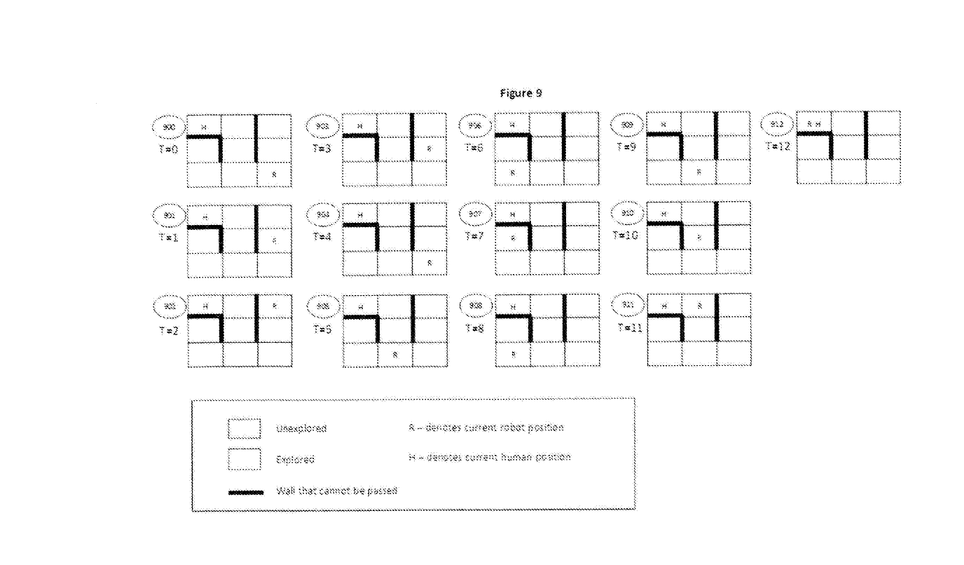

In FIGS. 8 and 9, the objective is for the robot to navigate to the location of the human as quickly as possible in response to a human instructing the robot to “Come here.” FIGS. 8 and 9 are illustrative of examples of how a robot may respond to such a command.

FIG. 8 illustrates the navigation of a robot to the location of a human, in which the robot has awareness of the exploration completed by the human, and of the past and current position of the human. The robot optimizes path planning with this information.

At grid 800, the robot is in the lower right position, the human is in the upper left position. The human has already explored all of the territories.

At grid 801, the robot has moved left, with awareness that moving up is an invalid path. At grid 802, the robot has moved up, with awareness that moving left is an invalid path. At grid 803, the robot has moved up. At grid 804, the robot has moved left in the task is complete.

FIG. 9 illustrates an example of the navigation of a robot to the location of a human. In this example, the robot has no awareness of the exploration completed by the human or the past and current position of the human.

At grid 900, the robot is in the lower right position, the human is in the upper left position. The human has already explored all of the territories.

At grid 901, the robot has moved up. The robot has no knowledge that this movement leads to a dead end. At grid 902, the robot has moved up. The robot has reached a dead-end. At grid 903, the robot has moved down. At grid 904, the robot has moved down. At grid 905, the robot has moved left. At grid 906, the robot has moved left. The robot has no knowledge that this movement leads to a dead-end. At grid 907 the robot has moved up. The robot is reached a dead-end. At grid 908, the robot has moved down. At grid 909, the robot has moved right. At grid 910 the robot has moved up. At grid 911, the robot has moved up. At grid 912, the robot has reached the human the upper left. The task is completed. The robot took significantly longer to complete the task compared to the example in FIG. 8. One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an recited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method for creating or updating a combined map using a collaborative human-robot swarm (HRS), comprising:
receiving at least one data input by a server or by at least one member of the collaborative HRS, from at least one human of the collaborative HRS moving through a first environment, the at least one human equipped with at least one human perception unit including a sensor payload, a computer/processor, and a data link;
receiving at least one data input at the server or at the at least one member of the collaborative HRS, from at least one robot of the collaborative HRS moving through a second environment, the at least one robot equipped with at least one robot perception unit including a sensor payload, a computer/processor, and a data link; and
processing the received data inputs from the at least one human and the at least one robot at the server or at the at least one member of the collaborative HRS, to create or update the combined map of the first and second environments.

2. The computer-implemented method of claim 1, further comprising:
transmitting the created or updated combined map to the at least one human, the at least one robot, or to at least one other member of the collaborative HRS.

3. The computer-implemented method of claim 1, further comprising:
integrating at least one of the human or robot perception units into an unmanned aerial vehicle (UAV), a helmet, a backpack, or a vest.

4. The computer-implemented method of claim 1, further comprising:
at least one of the sensor payloads of the human or robot perception units including a scanning Light Detection And Ranging (LIDAR), Sound Navigation And Ranging (SONAR), inertial measurement unit (IMU)|, Electro-Optical (EO) camera, Thermal camera, Depth camera, Near Infrared (NIR) camera, Compass, WiFi (wireless local area network (WLAN)), Global System for Mobile Communications (GSM), Long-Term Evolution (LTE), Code Division Multiple Access (CDMA), Near Field Communication (NFC), Global Positioning System (GPS), RF transmitter, RF receiver technology, or a combination thereof.

5. The computer-implemented method of claim 1, further comprising:
processing the data inputs from the at least one human perception unit and/or the at least one robot perception unit using Simultaneous Location And Mapping (SLAM) techniques.

6. The computer-implemented method of claim 1, further comprising:
configuring the computer/processor of at least one human or robot perception unit to run individual mapping software for generating a map of the first or second environment, respectively.

7. The computer-implemented method of claim 1, further comprising:
processing the data inputs from the at least one human perception unit and the at least one robot perception unit by generating and fusing maps together from the sensor payloads of the at least one human and the at least one robot perception units, respectively.

8. The computer-implemented method of claim 1, further comprising:
communicating between the at least one human and the at least one robot of the collaborative HRS directly or indirectly through the data links.

9. The computer-implemented method of claim 1, further comprising:
designating one or more members of the collaborative HRS as master members, wherein the master members control communications between the members of the collaborative HRS.

10. An apparatus, comprising:
at least one processor; and
at least one memory including computer program code for one or more programs, the at least one memory and the computer program code configured to, with the at least one processor, cause the apparatus to perform at least the following:
receive at least one data input by a server or by at least one member of a collaborative human-robot swarm (HRS), from at least one human of the collaborative HRS moving through a first environment, the at least one human equipped with at least one human perception unit including a sensor payload, a computer/processor, and a data link;
receive at least one data input at the server or at the at least one member of the collaborative HRS, from at least one robot of the collaborative HRS moving through a second environment, the at least one robot equipped with at least one robot perception unit including a sensor payload, a computer/processor, and a data link; and
process the received data inputs from the at least one human and the at least one robot at the server or at the at least one member of the collaborative HRS, to create or update the combined map of the first and second environments.

11. The apparatus of claim 10, further comprising causing the apparatus to:
transmit the updated or combined map to the at least one human, the at least one robot, or to at least one other member of the collaborative HRS.

12. The apparatus of claim 10, further comprising causing the apparatus to:
integrate at least one of the human or robot perception units into an unmanned aerial vehicle (UAV), a helmet, a backpack, or a vest.

13. The apparatus of claim 10, further comprising causing the apparatus to:
include at least one of the sensor payloads of the human or robot perception units to include a scanning Light Detection And Ranging (LIDAR). Sound Navigation And Ranging (SONAR), inertial measurement unit (IMU)|, Electro-Optical (EO) camera, Thermal camera, Depth camera, Near Infrared (NIR) camera, Compass, WiFi (wireless local area network (WLAN)), Global System for Mobile Communications (GSM), Long-Term Evolution (LTE), Code Division Multiple Access (CDMA), Near Field Communication (NFC), Global Positioning System (GPS), RF transmitter, RF receiver technology, or a combination thereof.

14. The apparatus of claim 10, further comprising causing the apparatus to:
process the data inputs from the at least one human perception unit and the at least one robot perception unit using Simultaneous Location And Mapping (SLAM) techniques.

15. The apparatus of claim 10, further comprising causing the apparatus to:
configure the computer/processor of at least one human or robot perception unit to run individual mapping software for generating a map of the first or second environment, respectively.

16. The apparatus of claim 10, further comprising causing the apparatus to:
process the data inputs from the at least one human perception unit and the at least one robot perception unit by generating and fusing maps together from the sensor payloads of the at least one human and the at least one robot perception units, respectively,

17. The apparatus of claim 10, further comprising causing the apparatus to:
communicate between the at least one human and the at least one robot of the collaborative HRS directly or indirectly through the data links.

18. The apparatus of claim 10, further comprising causing the apparatus to:
designate one or more members of the collaborative HRS as master members, wherein the master members control communications between the members of the collaborative HRS.

19. A system of a collaborative human-robot swarm (HRS) for creating or updating a combined map, comprising:
at least one human of the collaborative HRS moving through a first environment, the at least one human equipped with at least one human perception unit including a sensor payload, a computer/processor, and a data link for receiving and/or transmitting data to a server or to at least one member of the collaborative HRS; and
at least one robot of the collaborative HRS moving through a second environment, the at least one robot equipped with at least one robot perception unit including a sensor payload, a computer/processor, and a data link for receiving and/or transmitting data to the server or to the at least one member of the collaborative HRS,
wherein the server or the at least one other member of the collaborative HRS processes the received data inputs from the at least one human and the at least one robot to create or update the combined map of the first and second environments.

20. The system of a collaborative HRS of claim 19, wherein the created or updated combined map is transmitted to the at least one human, the at least one robot, or to at least one other member of the collaborative HRS.
